(19) United States
(12) Patent Application Publication
(10) Pub. No.: US 2015/0256930 A1
(43) Pub. Date: Sep. 10, 2015

(54) MASKING SOUND DATA GENERATING DEVICE, METHOD FOR GENERATING MASKING SOUND DATA, AND MASKING SOUND DATA GENERATING SYSTEM

(71) Applicant: Yamaha Corporation, Hamamatsu-shi (JP)

(72) Inventor: Takashi YAMAKAWA, Iwata-shi (JP)

(21) Appl. No.: 14/644,084

(22) Filed: Mar. 10, 2015

(30) Foreign Application Priority Data
Mar. 10, 2014 (JP) 2014-046805

(51) Int. Cl. H04R 3/00; G10L 21/0208

(52) U.S. Cl. CPC H04R 3/002; G10L 21/0208

(57) ABSTRACT

A masking sound data generating device includes a source sound data obtaining portion that obtains source sound data which represents a sound used in a generation of masking sound data, a speaker sound data obtaining portion that obtains speaker sound data which represents a voice of a speaker, a band level specifying portion that specifies each level of two or more frequency bands in the speaker sound data, and a band level setting portion that sets each level of two or more frequency bands in the source sound data in accordance with predetermined rules on the basis of the specified each level of the frequency bands in the speaker sound data to generate masking sound data which represents a masking sound. The predetermined rules are different to each other.

### BACKGROUND

The present invention relates to a sound masking technique.

There is a sound masking technique that prevents a conversation from being overheard by emitting a sound (masking sound) to impede transmission of information by sound (for example, voice).

JP-A-2006-267174, JP-A-2010-217883 and JP-A-06-186986 are exemplified as documents related to generation of a masking sound. In JP-A-2006-267174, there is proposed a technology that generates a masking sound hardly making a third person feel unpleasant by performing a frequency filtering process for a masking sound so that the frequency spectrum of the masking sound and a background noise is the same as the frequency spectrum of a voice of a speaker (an interlocutor). In JP-A-2010-217883, there is proposed a technology that generates a masking sound that does not cause noisiness and unnaturalness by dividing an envelope signal representing the envelope of each band of a target sound signal received from a room into multiple frames and multiplying a noise sound by the envelope signal obtained by randomly changing the order of the arrangement of frames in which the amplitude of the signal is greater than or equal to a lower limit threshold and less than or equal to an upper limit threshold. In JP-A-06-186986, there is proposed a technology that generates, although not for sound masking but as a sound for reducing the influence of a running noise of a vehicle impeding the reproduction of an electrically valid signal through a loudspeaker, a sound in which the level of each frequency band is individually adjusted depending on the instantaneous speed of a vehicle.

In the technologies illustrated in JP-A-2006-267174, JP-A-2010-217883 and JP-A-06-186986 as the related art, processes are performed for all frequency bands according to the same rule in the generation of a masking sound. However, not all of the frequency bands of a voice contribute equally to the transmission of information by voice. In addition, not all of the frequency bands of a masking sound equally give feelings of unpleasantness and discordance to a listener.

An object of the present invention is to provide a technology that generates a masking sound having high masking efficiency or a masking sound having less unpleasantness and discordance when compared with a masking sound generated without considering the contribution of each frequency band of the masking sound to the transmission of information or to feelings of unpleasantness and discordance given to a listener.

### SUMMARY

In order to achieve the above object, according to the present invention, there is provided a masking sound data generating device comprising:

a source sound data obtaining portion that obtains source sound data which represents a sound used in a generation of masking sound data;

a speaker sound data obtaining portion that obtains speaker sound data which represents a voice of a speaker which is a masking target;

a band level specifying portion that specifies each level of two or more frequency bands in the speaker sound data; and

a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound,

wherein the band level setting portion sets each level of at least two frequency bands among from the two or more frequency bands in the source sound data in accordance with the predetermined rules which are different to each other.

According to the present invention, there is also provided a method for generating masking sound data, comprising:

obtaining source sound data which represents a sound used in a generation of masking sound data;

obtaining speaker sound data which represents a voice of a speaker which is a masking target;

specifying each level of two or more frequency bands in the speaker sound data; and

setting each level of two or more frequency bands in the source sound data, corresponding to the two or more frequency bands in the speaker sound data, in accordance with predetermined rules on the basis of the each level of the frequency bands in the speaker sound data specified by a process of the specifying to generate masking sound data which represents a masking sound,

wherein in a process of the setting, each level of at least two frequency bands among from the two or more frequency bands in the source sound data is set in accordance with the predetermined rules which are different to each other.

According to the present invention, there is also provided a masking sound generating system comprising:

a sound receiving device that generates speaker sound data by receiving a voice of a speaker which is a masking target and outputs the speaker sound data;

a masking sound data generating device that generates masking sound data representing a masking sound; and

a sound emitting device that emits the masking sound data generated by the masking sound data generating device as the masking sound,

wherein the masking sound data generating device comprises:
a source sound data obtaining portion that obtains source sound data that represents a sound used in the generation of the masking sound data;
a speaker sound data obtaining portion that obtains the speaker sound data which is output from the sound receiving device;
a band level specifying portion that specifies each level of two or more frequency bands in the speaker sound data;
a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound; and
an outputting portion that outputs the masking sound data generated by the band level setting portion to the sound emitting device; and

wherein the band level setting portion sets each level of at least two frequency bands among from the two or more frequency bands in the source sound data in accordance with the predetermined rules which are different to each other.

According to the present invention, there is generated a masking sound in which the level of frequency bands is adjusted in accordance with the different rules for each frequency band depending on the contribution of each frequency band of the masking sound to the transmission of information or to feelings of unpleasantness and discordance given to a listener. This results in the generation of the masking sound having high masking efficiency or the masking sound having less unpleasantness and discordance.

### BRIEF DESCRIPTION OF THE DRAWINGS

FIG. 1 is a block diagram illustrating a configuration of a masking sound generating system according to an embodiment.

FIG. 2 is a diagram illustrating a parameter used by a masking sound data generating device according to the embodiment.

FIG. 3 is a diagram illustrating a parameter used by the masking sound data generating device according to the embodiment.

FIG. 4 is a diagram illustrating a parameter used by the masking sound data generating device according to the embodiment.

FIG. 5 is a block diagram illustrating the configuration of a masking sound generating system according to a first modification example.

FIG. 6 is a block diagram illustrating the configuration of a masking sound generating system according to a second modification example.

FIG. 7 is a block diagram illustrating the configuration of a masking sound generating system according to a third modification example.

FIG. 8 is a block diagram illustrating the configuration of a masking sound generating system according to a fourth modification example.

FIG. 9 is a block diagram illustrating the configuration of a masking sound generating system according to a fifth modification example.

FIG. 10 is a block diagram illustrating the configuration of a masking sound generating system according to a sixth modification example.

FIG. 11 is a block diagram illustrating the configuration of a masking sound generating system according to a seventh modification example.

FIG. 12 is a block diagram illustrating the configuration of a masking sound generating system according to an eighth modification example.

FIG. 13 is a diagram illustrating a parameter used by the masking sound data generating device.

FIG. 14 is a diagram illustrating a parameter used by the masking sound data generating device.

FIG. 15 is a diagram illustrating a parameter used by the masking sound data generating device.

FIG. 16 is a diagram illustrating a parameter used by the masking sound data generating device.

FIG. 17 is a flowchart illustrating an outline of the operation of the masking sound data generating device.

### DETAILED DESCRIPTION OF EXEMPLARY EMBODIMENTS

### 1. Embodiment

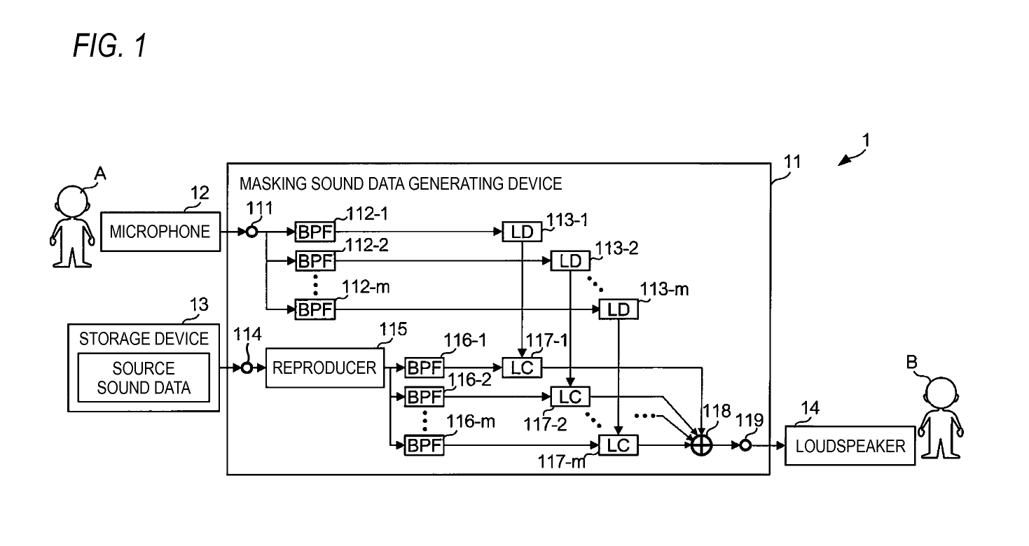

Hereinafter, a description will be provided for the configuration and the operation of a masking sound generating system 1 according to an embodiment of the present invention. FIG. 1 is a block diagram illustrating the configuration of the masking sound generating system 1. The masking sound generating system 1 includes a masking sound data generating device 11, a microphone 12, a storage device 13, and a loudspeaker 14. The masking sound data generating device 11 generates sound data (referred to as “masking sound data” hereinafter) representing a masking sound. The microphone 12 is a sound receiving device which generates sound data (referred to as “speaker sound data” hereinafter) by receiving the sound of a voice of a speaker A (a voice of a masking target). The storage device 13 stores sound data (referred to as “source sound data” hereinafter) representing a sound used as a source for generating the masking sound data. The loudspeaker 14 is a sound emitting device emitting a sound represented by the masking sound data, which is generated by the masking sound data generating device 11, as a masking sound to the space where a listener B (an opponent serving as a target for impeding the transmission of the content of the voice of the speaker A) is present.

The source sound data stored in the storage device 13 is data generated by performing a process of obfuscating a voice (for example, a process of reversing data in a block divided by a constant length of time in the direction of a time axis or swapping the order of blocks) for the sound data representing a voice of people with various attributes such as a person with low tone and a person with high tone, a male and a female, and an adult and a child reading standard Japanese text that includes vowel and consonant sounds approximately equally.

The masking sound data generating device 11 includes an input interface (IF) 111, BPFs 112-1 to 112-m, and LDs 113-1 to 113-m. The input IF 111 receives input of the speaker sound data generated by the microphone 12. The BPFs 112-1 to 112-m (referred to collectively as a “BPF 112” hereinafter) are a group of bandpass filters that divides the speaker sound data input from the input IF 111 into m (where m≧2) frequency bands and generates sound data (referred to as “band speaker sound data” hereinafter) for each frequency band. The LDs 113-1 to 113-m (referred to collectively as an “LD 113” hereinafter) are level detectors specifying each level of the band speaker sound data generated by the BPF 112. The input IF 111 constitutes a speaker sound data obtaining portion. The BPF 112 and the LD 113 constitute a band level specifying portion.

The masking sound data generating device 11 further includes an input IF 114, a reproducer 115, BPFs 116-1 to 116-m, and LCs 117-1 to 117-m. The input IF 114 receives input of the source sound data stored in the storage device 13. The reproducer 115 sequentially reads and outputs the source sound data input into the input IF 114. The BPFs 116-1 to 116-m (referred to collectively as a “BPF 116” hereinafter) are a group of bandpass filters that divides the source sound data output from the reproducer 115 into m frequency bands and generates sound data (referred to as “band source sound data” hereinafter) for each frequency band. The LCs 117-1 to 117-m (referred to collectively as an “LC 117” hereinafter) are circuits (level controllers) that change the level of the band source sound data generated by the BPF 116 having the corresponding branch number as the LC 117 among the BPFs 116-1 to 116-m on the basis of the level of the band speaker sound data specified by the LD 113 having the corresponding branch number as the LC 117 among the LDs 113-1 to 113-m. The input IF 114 constitutes a source sound data obtaining portion.

The masking sound data generating device 11 further includes an adder 118 and an output IF 119. The adder 118 generates sound data (referred to as “masking sound data” hereinafter) representing a masking sound by adding the pieces of band source sound data of which the level is changed by the LC 117. The output IF 119 outputs the masking sound data generated by the adder 118 to the loudspeaker 14. The adder 118 constitutes a band level setting portion along with the BPF 116 and the LC 117.

Each band of the BPF 112, the LD 113, the BPF 116, and the LC 117 corresponds to each other one-on-one. Specifically, given that k is an arbitrary natural number in 1≦k≦m, the LD 113-k obtains the band speaker sound data from the BPF 112-k and specifies the level of the band speaker sound data. The LC 117-k obtains the band source sound data from the BPF 116-k and changes the level of the band source sound data on the basis of the level of the band speaker sound data specified by the LD 113-k.

Each of the LCs 117-1 to 117-m has a memory. The memory stores level change parameters that is set in each of the LCs 117-1 to 117-m. The level change parameters corresponding to each of the LCs 117-1 to 117-m include gain specification functions GR-1 to GR-m (referred to collectively as a “gain specification function GR” hereinafter) and time constants TC-1 to TC-m (referred to collectively as a “time constant TC” hereinafter).

The gain specification functions GR-1 to GR-m are functions representing a correspondence between the level of the band speaker sound data (referred to as a “reference signal level” hereinafter) specified by each of the LDs 113-1 to 113-m and the convergence value of a gain (referred to as a “target gain” hereinafter) in a case where the LCs 117-1 to 117-m change the level of the band source sound data obtained by each of the BPFs 116-1 to 116-m. The time constants TC-1 to TC-m are numerical values representing the response speed of gains in the changing of the level by the LCs 117-1 to 117-m until converging to the target gains determined by the gain specification functions GR-1 to GR-m. Each of the LCs 117-1 to 117-m controls the level of the band source sound data in each frequency so that the level converges to the target gain corresponding to the reference signal level represented by the gain specification function GR at the response speed represented by the time constant TC. At least two of the gain specification functions GR-1 to GR-m are different from each other so as to obtain desirable masking sound data. Also, regarding the time constants TC-1 to TC-m, at least two of the time constants TC-1 to TC-m are different from each other so as to obtain desirable masking sound data.

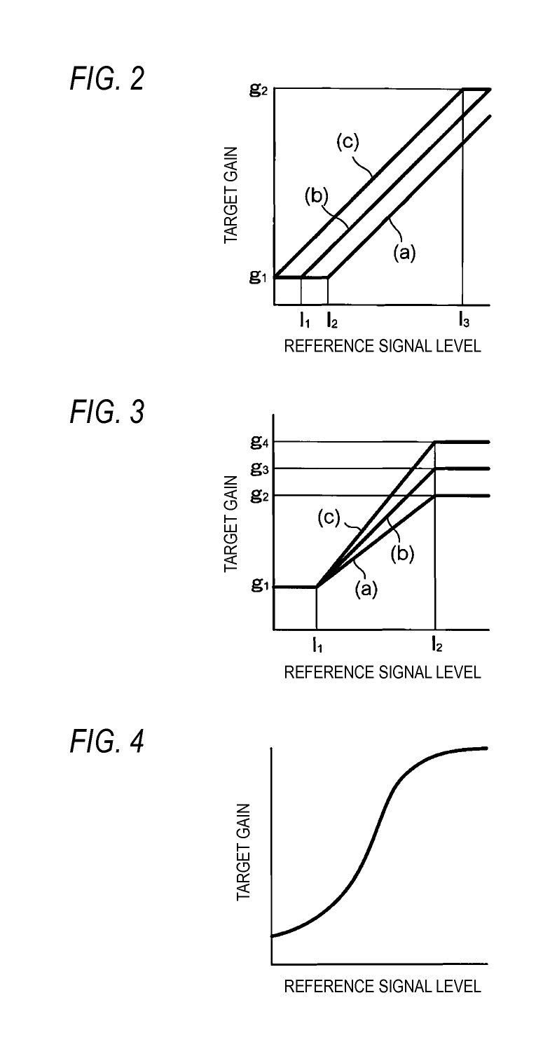

FIG. 2 illustrates three examples ((a) to (c)) of the gain specification function GR with each graph. The graph (a) in FIG. 2 has a lower limit of the target gain. When the reference signal level is less than or equal to I₂, a constant value g₁ is output as a target gain regardless of the magnitude of the reference signal level. The graph (b) also has a lower limit of the target gain. When the reference signal level is less than or equal to I₁ (I₁<I₂), the constant value g₁ is output as a target gain regardless of the magnitude of the reference signal level. The graph (c) has an upper limit of the target gain. When the reference signal level is greater than or equal to I₃ (I₂<I₃), a constant value g₂ (g₁<g₂) is output as a target gain regardless of the magnitude of the reference signal level.

In a comparison between the three examples of the gain specification function GR illustrated with the graphs (a) to (c) in FIG. 2, the graph (b) outputs the same or a greater target gain than the graph (a), and the graph (c) outputs the same or a greater target gain than the graph (b) with respect to the same input of the reference signal level in the entire region of the reference signal level. Accordingly, in sound masking, for example, the gain specification function GR of the graph (a) is set as a level change parameter in the LC 117 of a frequency band for less significant information in the voice of which the transmission is to be impeded. The gain specification function GR of the graph (c), for example, is set as a level change parameter in the LC 117 of a frequency band for more significant information in the voice of which the transmission is to be impeded.

A frequency band including a great number of frequency components of formants or consonants in the voice to mask is exemplified as a frequency band for more significant information in the voice.

FIG. 3 illustrates another three examples ((a) to (c)) of the gain specification function GR with each graph. All of the graphs (a) to (c) in FIG. 3 have a lower limit and an upper limit of the target gain. That is to say, all of the graphs (a) to (c) output the constant value g₁ as a target gain regardless of the magnitude of the reference signal level when the reference signal level is less than or equal to I₁. In addition, all of the graphs (a) to (c) output a constant value as a target gain regardless of the magnitude of the reference signal level when the reference signal level is greater than or equal to I₂ (I₁<I₂). However, the value of the target gain output by each of the graphs (a) to (c) is different when the reference signal level is greater than or equal to I₂ (I₁<I₂). The graphs (a), (b), and (c) respectively output the constant value g₂, a constant value g₃, and a constant value g₄ (g₁<g₂<g₃<g₄).

In a comparison between the three examples of the gain specification function GR illustrated with the graphs (a) to (c) in FIG. 3, the gain specification function GR of the graph (b) outputs a greater target gain than that of the graph (a), and the gain specification function GR of the graph (c) outputs a greater target gain than that of the graph (b) with respect to the same input of the reference signal level when the reference signal level is greater than or equal to I₁. As the level of the voice to mask is greater, a possibility of overhearing of the content of the voice by a listener also increases. Thus, it is more significant to prevent the transmission of information by such a high-level voice. Accordingly, in a case of using these three examples of the gain specification function GR, for example, the gain specification function GR of the graph (a) outputting a small target gain in the region where the reference signal level is great is set as a level change parameter in the LC 117 of a less significant frequency band. The gain specification function GR of the graph (c) outputting a large target gain in the region where the reference signal level is great is set as a level change parameter in the LC 117 of a more significant frequency band.

In this manner, in sound masking, the optimum gain specification function GR is set for each frequency band depending on the importance of the information in the voice of which the transmission is to be impeded. This process can increase the masking efficiency of the masking sound data generated by the masking sound data generating device 11.

It takes a small amount of processing time for the masking sound generated depending on the level of the speaker sound data for each frequency band to be output to the loudspeaker 14 after the masking sound data generating device 11 receives the speaker sound data from the microphone 12. Accordingly, there is a slight difference between the reference signal level for each frequency band at the time of the masking sound data generating device 11 obtaining the speaker sound data and the level of the masked voice for each frequency band at the time of the emission of the masking sound. However, it is apparently considered that the reference signal level for each frequency band at the time of the masking sound data generating device 11 obtaining the speaker sound data approximately represents the level of the masked voice for each frequency band at the time of the emission of the masking sound when the processing time or the like is short enough in the masking sound data generating device 11.

The gain specification function GR is not limited to those changing linearly as illustrated in FIG. 2 and FIG. 3. For example, the gain specification function GR may be non-linear as illustrated in FIG. 4.

The data that is stored in the memory of the LC 117 and represents the gain specification function GR, for example, may have any format of data representing a functional equation, data representing a correspondence table between the reference signal level and the target gain, and the like. The LC 117 may be configured as an analog circuit or a digital circuit outputting the target gain represented by the gain specification function GR with respect to the input of the reference signal level.

The time constant TC, that is another level change parameter and is set in the LC 117, represents the response speed of the gain until reaching the target gain that is output according to the gain specification function GR depending on the input reference signal level. Accordingly, the LC 117 set with a great time constant TC slowly follows the input reference signal level, and the gain changes smoothly in the changing of the level of the band source sound data by the LC 117 even when the reference signal level changes rapidly. Meanwhile, the LC 117 set with a small time constant TC quickly follows the input reference signal level, and the gain changes rapidly in the changing of the level of the band source sound data by the LC 117 when the reference signal level changes rapidly.

Regarding the frequency band including a great number of frequency components of consonants, for example, it is desirable, in view of a masking effect, that the level of the masking sound changes rapidly depending on the reference signal level so as to mask consonants of which the level changes rapidly. Accordingly, the LC 117 of a frequency band including a great number of frequency components of consonants is set with a small time constant TC. This process can improve the masking effect of the masking sound data generated by the masking sound data generating device 11.

A listener may feel discordant and unpleasant similarly to motion sickness when, for example, listening to a sound of which the level of a frequency band of approximately 30 Hz to 200 Hz changes with jiggly. For this reason, regarding a frequency band of approximately 30 Hz to 200 Hz, it is desirable, in view of reducing discordant and unpleasant feelings of a listener, that the level of the masking sound smoothly changes, compared with the change of the reference signal level. Accordingly, the LC 117 of a frequency band of approximately 30 Hz to 200 Hz is set with a great time constant TC. This process can reduce feelings of discordance and unpleasantness given to a listener due to the masking sound data generated by the masking sound data generating device 11.

The operation of the masking sound generating system 1 is as follows. First, each of the BPFs 112-1 to 112-m continuously receives the speaker sound data representing the voice of the speaker A from the microphone 12 through the input IF 111. The BPFs 112-1 to 112-m generate the band speaker sound data by performing filtering processes for the speaker sound data received from the microphone 12 and pass the band speaker sound data to the LDs 113-1 to 113-m. Each of the LDs 113-1 to 113-m obtains the envelope of the spectrum of the sound represented by the band speaker sound data received from each of the BPFs 112-1 to 112-m and specifies the level of the envelope. Each of the LDs 113-1 to 113-m passes the specified level to each of the LCs 117-1 to 117-m as the reference signal level.

Concurrently with the above processes by the input IF 111, the BPF 112, and the LD 113, the reproducer 115 sequentially reads the source sound data from the storage device 13 through the input IF 114 and passes the source sound data to the BPFs 116-1 to 116-m. The BPFs 116-1 to 116-m generate the band source sound data by performing filtering processes for the received source sound data and pass the band source sound data to the LCs 117-1 to 117-m respectively.

Each of the LCs 117-1 to 117-m receives the reference signal level passed sequentially from each of the LDs 113-1 to 113-m and receives the band source sound data passed sequentially from each of the BPFs 116-1 to 116-m. Each of the LCs 117-1 to 117-m specifies the target gain depending on the received reference signal level on the basis of each of the gain specification functions GR-1 to GR-m and determines the current gain respectively so that the gain reaches the specified target gain at the response speed represented by the time constants TC-1 to TC-m respectively. The LC 117 changes the level of the band source sound data received from the BPFs 116-1 to 116-m so as to obtain the determined gain and passes to the adder 118 the band source sound data of which the level is changed.

The adder 118 generates the masking sound data by adding the pieces of band source sound data received from each of the LCs 117-1 to 117-m. The adder 118 outputs the generated masking sound data to the loudspeaker 14 through the output IF 119. The loudspeaker 14 emits the masking sound to the space where the listener B is present according to the masking sound data input from the masking sound data generating device 11. This process results in the prevention of the content of the voice of the speaker A from being overheard by the listener B.

Accordingly, the masking sound generating system 1, as described above, generates the masking sound data of which the level is adjusted for each frequency band depending on the level of the speaker sound data according to the gain specification function GR and the time constant TC set for each frequency band. Accordingly, a masking sound having a high masking effect or a masking sound less giving feelings of unpleasantness and discordance to a listener is emitted by setting the gain specification function GR and the time constant TC appropriately for each frequency band.

### 2. Modification Example

Descriptions will be provided below for modification examples of the embodiment described above. In descriptions below, the same reference signs will be used for the same units as the configurational units provided in the masking sound generating system 1 above. In addition, descriptions will be mainly provided for differences between the masking sound generating system 1 and the masking sound generating systems according to the modification examples, and descriptions of common points will be appropriately omitted.

### 2.1. First Modification Example

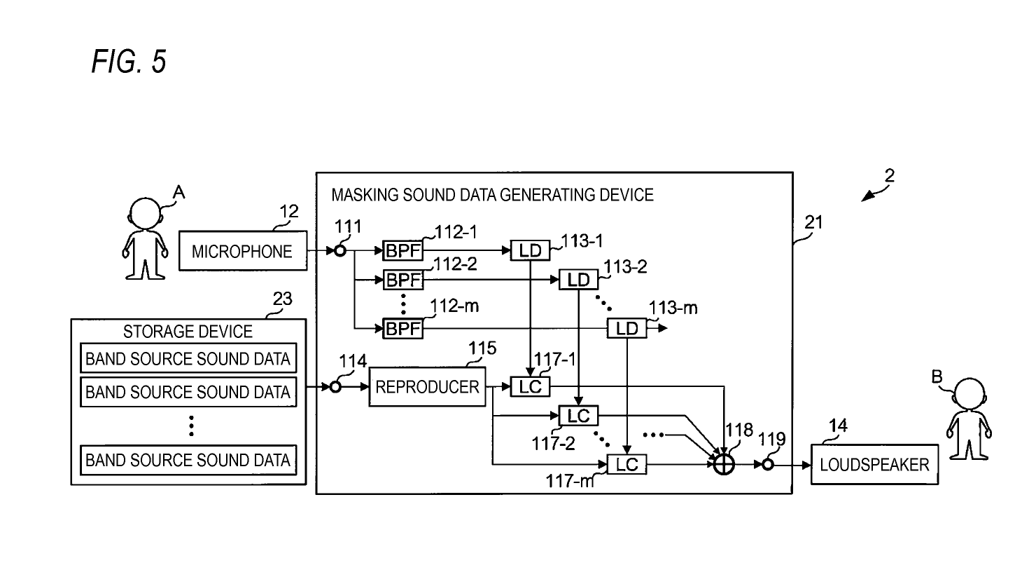

FIG. 5 is a block diagram illustrating the configuration of a masking sound generating system 2 according to a first modification example. The masking sound generating system 2 includes a storage device 23 instead of the storage device 13 provided in the masking sound generating system 1. The storage device 23 stores the band source sound data that represents a plurality of source sounds in multiple frequency bands which are divided in advance. In addition, the masking sound generating system 2 includes a masking sound data generating device 21 instead of the masking sound data generating device 11 provided in the masking sound generating system 1. The masking sound data generating device 21 does not includes the BPFs 116-1 to 116-m provided in the masking sound data generating device 11. The masking sound data generating device 21 directly passes the band source sound data to the corresponding LCs 117-1 to 117-m respectively, the band source sound data being read by the reproducer 115 from the storage device 23 through the input IF 114.

Accordingly, in the masking sound generating system 2 having the above configuration, the masking sound data generating device 21 does not need to perform a process of dividing the source sound data into frequency bands, thus reducing a processing load for the dividing the frequency band of the source sound data. The masking sound generating system 1 uses multiple pieces of band source sound data obtained by the BPF 116 dividing the band of one source sound data. Thus, the source sound data, which is the original data of the multiple pieces of band source sound data, cannot be different for each frequency band. On the contrary, the masking sound generating system 2 can use the band source sound data obtained by dividing the band of different pieces of source sound data for each frequency band. Thus, the masking sound generating system 2 emits a more desirable masking sound by using the band source sound data obtained by dividing the band of the optimum source sound data for each frequency band.

### 2.2. Second Modification Example

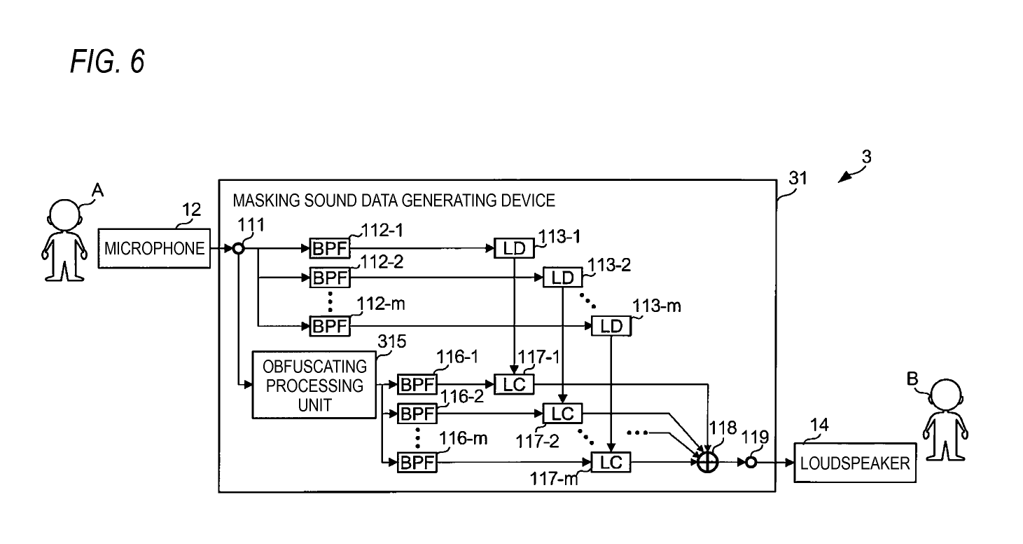

FIG. 6 is a block diagram illustrating the configuration of a masking sound generating system 3 according to a second modification example. The masking sound generating system 3 includes a masking sound data generating device 31 instead of the masking sound data generating device 11 provided in the masking sound generating system 1. The masking sound data generating device 31 includes an obfuscating processing unit 315 instead of the reproducer 115 provided in the masking sound data generating device 11. The obfuscating processing unit 315 is a processing unit performing a process of obfuscating the phonetic or the linguistic meaning of the speaker sound data for the speaker sound data input from the microphone 12 through the input IF 111. That is to say, the masking sound generating system 3 uses, as the source sound data, the obfuscated version of the speaker sound data that represents the voice of the speaker A and is received by the microphone 12 in real time instead of the source sound data prepared in advance. Thus, the masking sound generating system 3 does not include the storage device 13 for storing the source sound data prepared in advance.

When obtaining the speaker sound data sequentially from the microphone 12 through the input IF 111 in real time, the obfuscating processing unit 315 stores the obtained speaker sound data temporarily in a buffer (temporary storage), divides the speaker sound data into blocks by a constant length of time, and reverses the data in the divided blocks in the direction of the time axis. Thereafter, the obfuscating processing unit 315, for example, generates the source sound data by swapping (changing) the order of those blocks randomly. The obfuscating process performed by the obfuscating processing unit 315 is not limited to this process. The obfuscating processing unit 315 may adopt various known obfuscating processes. The obfuscating processing unit 315 passes the generated source sound data to each of the BPFs 116-1 to 116-m. The BPF 116 constitutes the source sound data obtaining portion.

Generally, a masking sound having higher similarity of acoustic characteristics with the voice to mask has a high masking effect. Accordingly, when a masking sound is obfuscated, it is preferable to use, as the masking sound, a masking sound generated on the basis of the voice of a speaker having high similarity of acoustic characteristics with the voice to mask of the same speaker. The masking sound generating system 3 provided with the above configuration generates the source sound data on the basis of the speaker sound data representing the voice of the speaker A and uses the source sound data in generating the masking sound data. As a result, the masking sound generating system 3 emits a masking sound having a high masking effect when compared with the masking sound generating system 1.

The voice of the speaker A received in real time is used as the source sound in the masking sound generating system 3. Accordingly, the level of the band source sound data prior to level adjustment by the LC 117 changes in connection with the level of the voice to mask of the speaker A.

Generally, the level of the masking sound required in masking increases as the level of the voice to mask is greater. Accordingly, it is desirable that the level of the masking sound changes in connection with the level of the voice to mask. However, the target gain specified by the LC 117 according to the gain specification function GR increases as the reference signal level is higher. Thus, when the time constant TC is small, and the level of the voice of the speaker A is high, the LC 117 may further increase the level of the band source sound data of which the level is previously high in response to the increasing level of the voice of the speaker A. This may result in the generation of the masking sound data having unnecessarily high volume.

To avoid such a problem, for example, the masking sound data generating device 21 may be configured to include a level restriction unit that restricts the level of the speaker sound data in the obfuscating process by the obfuscating processing unit 315 or the level of the band source sound data after band division by the BPF 116 to a predetermined value or less.

### 2.3. Third Modification Example

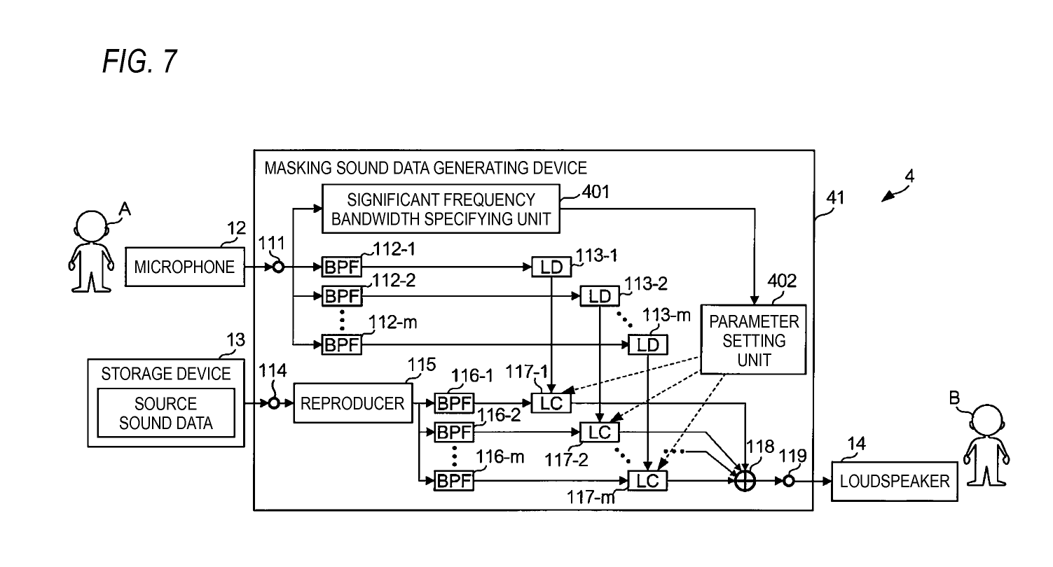

FIG. 7 is a block diagram illustrating the configuration of a masking sound generating system 4 according to a third modification example. The masking sound generating system 4 includes a masking sound data generating device 41 instead of the masking sound data generating device 11 provided in the masking sound generating system 1. The masking sound data generating device 41 includes a significant frequency band specifying unit 401 and a parameter setting unit 402. The parameter setting unit 402 constitutes the band level setting portion along with the BPF 116, the LC 117, and the adder 118.

The significant frequency band specifying unit 401 analyzes the speaker sound data input from the microphone 12 through the input IF 111. With respect to the voice of the speaker A represented by the speaker sound data, the significant frequency band specifying unit 401 specifies a particularly significant frequency band (for example, a frequency band including the first formant or the first consonant component of which the level is greater than or equal to a predetermined threshold (referred to as an “significant frequency band” hereinafter)) at a predetermined time interval (for example, at 100 to 500 ms) after sound masking is performed. Then, the significant frequency band specifying unit 401 passes to the parameter setting unit 402 significant band identification data for identifying the specified significant frequency band.

Each time the parameter setting unit 402 obtains the significant band identification data, the parameter setting unit 402 sets the gain specification function GR (for example, the gain specification function GR represented by the graph (c) in FIG. 2 or the graph (c) in FIG. 3) and the time constant TC (for example, a small time constant TC in a case of the significant frequency band including a great number of frequency components of consonants) in the LC 117 of a frequency band identified by the significant band identification data. When the frequency band specified as the significant frequency band is no longer the significant frequency band, the parameter setting unit 402 sets a default gain specification function GR and a default time constant TC in the LC 117 of the frequency band. Accordingly, the LC 117 changes the level of the band source sound data according to different level change parameters depending on whether the corresponding frequency band is the significant frequency band.

The masking sound generating system 4 having the above configuration specifies the significant frequency band in the voice of a current speaker and sets appropriate level change parameters for the significant frequency band in the LC 117 corresponding to the frequency band specified as the significant frequency band. Thus, the masking sound generating system 4 emits a masking sound having a high masking effect regardless of the change of a speaker even when the significant frequency band in the voice is different depending on the speaker.

The significant frequency band specifying unit 401 may specify the significant frequency band by using the following method in addition to the above method of analyzing the speaker sound data and specifying the significant frequency band in real time.

When, for example, the significant frequency band is fixedly determined in advance, the significant frequency band specifying unit 401 may store the significant band identification data for identifying the significant frequency band and may pass the significant band identification data to the parameter setting unit 402. Alternatively, the parameter setting unit 402 may store the significant band identification data for identifying the significant frequency band. In this case, the parameter setting unit 402 also performs the function of the significant frequency band specifying unit 401.

In addition to the first formant and the first consonant, the significant frequency band specifying unit 401 specifies the significant frequency band also on the basis of characteristics of a speaker or the voice of a speaker such as the sex and the age of a speaker, the language of the voice of a speaker, the speech rate of the voice of a speaker, the pitch of the voice of a speaker, and the volume of the voice of a speaker. For example, the significant frequency band is determined in advance for each characteristic of a speaker or the voice of a speaker such as the sex and the age of a speaker, the language of the voice of a speaker, the speech rate of the voice of a speaker, the pitch of the voice of a speaker, and the volume of the voice of a speaker. The significant frequency band specifying unit 401 stores the significant band identification data for identifying the corresponding significant frequency band for each of the characteristics of a speaker or the voice of a speaker. Then, when a user (for example, a speaker) of the masking sound generating system 4 inputs characteristics of the speaker or the voice of the speaker into the masking sound generating system 4, the significant frequency band specifying unit 401 passes the significant band identification data corresponding to the input characteristics to the parameter setting unit 402. The significant frequency band specifying unit 401, independently of the input of characteristics of a speaker or the voice of a speaker, may specify characteristics of a speaker or the voice of a speaker such as the sex and the age of a speaker, the language of the voice of a speaker, the speech rate of the voice of a speaker, the pitch of the voice of a speaker, and the volume of the voice of a speaker by analyzing the speaker sound data.

### 2.4. Fourth Modification Example

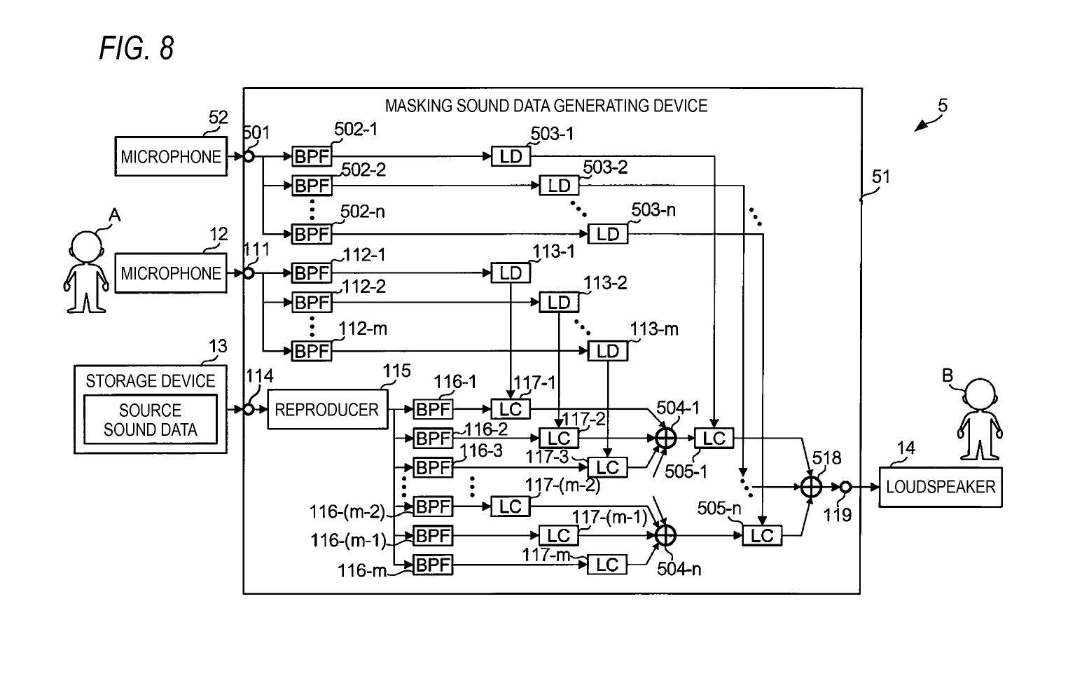

FIG. 8 is a block diagram illustrating the configuration of a masking sound generating system 5 according to a fourth modification example. The masking sound generating system 5 includes a microphone 52 in addition to the microphone 12 receiving the voice of the speaker A. The microphone 52 receives a background noise in the space where the speaker A is present (or the space where the listener B is present) and generates sound data (referred to as “background noise data” hereinafter).

The masking sound generating system 5 includes a masking sound data generating device 51 instead of the masking sound data generating device 11 provided in the masking sound generating system 1. The masking sound data generating device 51 includes an input IF 501, BPFs 502-1 to 502-n, and LDs 503-1 to 503-n. The input IF 501 receives input of the background noise data generated by the microphone 52. The BPFs 502-1 to 502-m (referred to collectively as a “BPF 502” hereinafter) are a group of bandpass filters that divides the background noise data input from the input IF 501 into n (where n is a factor of m apart from 1) frequency bands and generates sound data (referred to as “band background noise data” hereinafter) for each frequency band. The LDs 503-1 to 503-m (referred to collectively as an “LD 503” hereinafter) are level detectors specifying each level of the band background noise data generated by the BPF 502. The input IF 501 constitutes background noise data obtaining portion. The BPF 502 and the LD 503 constitute the band level specifying portion along with the BPF 112 and the LD 113.

The masking sound data generating device 51 further includes adders 504-1 to 504-n and LCs 505-1 to 505-n. The adders 504-1 to 504-n (referred to collectively as an “adder 504” hereinafter) are disposed for each of n groups obtained by grouping the adjacent LCs 117-1 to 117-m by (m/n). The adders 504-1 to 504-n add and output the pieces of band source sound data of which the level is changed by (m/n) numbers of the LC 117 in a group. The LCs 505-1 to 505-n (referred to collectively as an “LC 505” hereinafter) are disposed for each of the adders 504-1 to 504-n and change the level of the added band source sound data output from the adder 504 on the basis of the level of the band background noise data specified by the LDs 503-1 to 503-n.

The masking sound data generating device 51 further includes an adder 518 instead of the adder 118 provided in the masking sound data generating device 11. The adder 518 generates the masking sound data by adding n pieces of band source sound data, which result from the addition by the adders 504-1 to 504-n, of which the level is changed by the LCs 505-1 to 505-n and outputs the added band source sound data to the loudspeaker 14 through the output IF 119. The adder 518 constitutes the band level setting portion along with the BPF 116, the LC 117, the adder 504, and the LC 505.

The n frequency bands corresponding to each of the BPFs 502-1 to 502-n match n frequency bands obtained by grouping and combining continuous m frequency bands corresponding to each of the BPFs 116-1 to 116-m by (m/n). That is to say, when, for example, m=12, and n=4, the frequency band of the BPF 502-1 matches three continuous frequency bands corresponding to the BPFs 116-1 to 116-3. The frequency band of the BPF 502-2 matches three continuous frequency bands corresponding to the BPFs 116-4 to 116-6. The frequency band of the BPF 502-3 matches three continuous frequency bands corresponding to the BPFs 116-7 to 116-9. The frequency band of the BPF 502-4 matches three continuous frequency bands corresponding to the BPFs 116-10 to 116-12.

Each of the LCs 505-1 to 505-n includes a memory. The memory stores the gain specification function GR and the time constant TC set in each of the LCs 505-1 to 505-n as the level change parameters. Each of the LCs 505-1 to 505-n receives, as the reference signal level, the level specified by the LD 503 having the corresponding branch number as the LC 505 among the LDs 503-1 to 503-n and controls the level of the band source sound data mixed by the adder 504 having the corresponding branch number as the LC 505 among the adders 504-1 to 504-n so that the level converges to the target gain corresponding to the reference signal level represented by the preset gain specification function GR at the response speed represented by the preset time constant TC.

The masking sound generating system 5 having the above configuration adjusts the level of the masking sound data for each frequency band depending on the level of a background noise for each frequency band. Regarding, for example, a frequency band having a high level of a background noise, a listener hardly feels strident for the masking sound having a comparatively high level. Accordingly, the masking sound generating system 5 sets the gain specification function GR such as those illustrated in the graph (c) in FIG. 2 and the graph (c) in FIG. 3 in the LCs 505-1 to 505-n. Thus, a masking sound having a high masking effect is emitted without increasing unpleasant feelings of a listener.

The masking sound generating system 5 is configured to have n frequency bands in the adjustment of the level of the source sound data according to the background noise data representing a background noise, and the number of frequency bands n is smaller than the number of frequency bands m in the adjustment of the level of the source sound data according to the speaker sound data representing the voice of the speaker A. The reason is that since a background noise is not to be masked, it is not necessary to control each frequency band of a background noise finely when compared with the voice of the speaker A which is to be masked. In this manner, by setting n to be smaller than m, the number of the BPF 502, the LD 503, and the LC 505 can be decreased when compared with a case where n is equal to m. This process can simplify the configuration of the masking sound data generating device 51 and can reduce a processing load. However, n and m may be equal when the masking sound data generating device 51 has sufficient processing performance. In that case, the adder 504 is not necessary.

The time constant TC set in the LC 505 is set to a greater value than that of the time constant TC set in the LC 117. The reason is that a background noise may include an impulse sound that does not need to be masked, and emitting a masking sound of which the level changes promptly following an impulse sound increases unpleasant feelings of a listener unnecessarily and thus is not desirable. Particularly, when the LC 505 having a high frequency band is set with a greater value of the time constant TC than the LC 505 having a low frequency band, this process can reduce the influence of an impulse sound included in a background noise on the masking sound and thus reduces unpleasant feelings of a listener desirably. Accordingly, the masking sound generating system 5 emits a masking sound of which the level promptly follows the voice of a speaker for each frequency band and gradually follows a background noise.

### 2.5. Fifth Modification Example

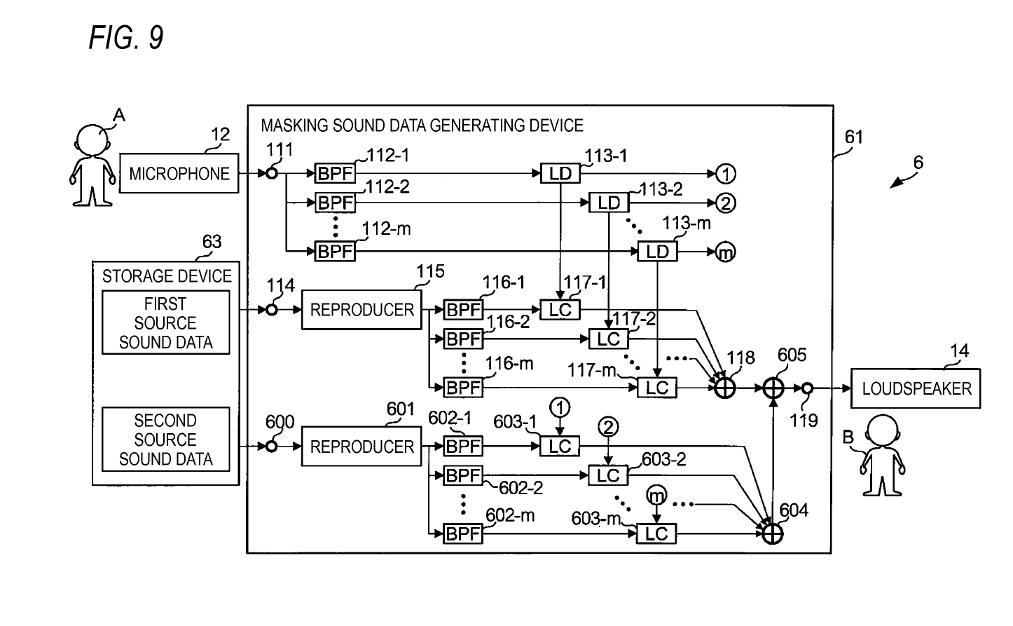

FIG. 9 is a block diagram illustrating the configuration of a masking sound generating system 6 according to a fifth modification example. The masking sound generating system 6 includes a storage device 63 instead of the storage device 13 provided in the masking sound generating system 1. The storage device 63 stores two different pieces of source sound data (first source sound data and second source sound data). The first source sound data stored in the storage device 63 is sound data that is similar to the source sound data stored in the storage device 13 and is obtained by performing the obfuscating process for the voice data. Meanwhile, the second source sound data is sound data representing a sound found in nature or in the environment (referred to as an “environmental sound” hereinafter), such as a sound of wavelets and the warbling of birds, that does not excessively draw attention and does not give a feeling of unpleasantness. The second source sound data is added at the time of the generation of the masking sound data so as not to mask the voice of a speaker and also reduce unpleasantness caused by the masking sound.

The masking sound generating system 6 includes a masking sound data generating device 61 instead of the masking sound data generating device 11 provided in the masking sound generating system 1. The masking sound data generating device 61 includes an input IF 600 in addition to the input IF 114 receiving the input of the first source sound data stored in the storage device 63. The input IF 600 receives the input of the second source sound data stored in the storage device 63. In addition, the masking sound data generating device 61 includes a reproducer 601. The reproducer 601 sequentially reads and outputs the second source sound data input into the input IF 600.

The masking sound data generating device 61 further includes BPFs 602-1 to 602-m and LCs 603-1 to 603-m. The BPFs 602-1 to 602-m (referred to collectively as a “BPF 602” hereinafter) are a group of bandpass filters that divides the second source sound data output from the reproducer 601 into m frequency bands and generates sound data (referred to as “band second source sound data” hereinafter) for each frequency band. The LCs 603-1 to 603-m (referred to collectively as an “LC 603” hereinafter) are circuits that change the level of the band second source sound data generated by the BPF 602 having the corresponding branch number as the LC 603 among the BPFs 602-1 to 602-m on the basis of the level of the band speaker sound data specified by the LD 113 having the corresponding branch number as the LC 603 among the LDs 113-1 to 113-m.

The masking sound data generating device 61 further includes an adder 604 and an adder 605. The adder 604 generates environmental sound data representing the environmental sound added to the masking sound by adding the pieces of band second source sound data of which the level is changed by the LC 603. The adder 605 generates the masking sound data representing a masking sound giving less unpleasantness by adding the masking sound data generated by the adder 118 and the environmental sound data generated by the adder 604. The adder 605 outputs the generated masking sound data to the loudspeaker 14 through the output IF 119. The adder 604 and the adder 605 constitute the band level setting portion along with the BPF 116, the LC 117, the adder 118, the BPF 602, and the LC 603.

Each of the LCs 603-1 to 603-m includes a memory. The memory stores the gain specification function GR and the time constant TC set in each of the LCs 603-1 to 603-m as the level change parameters. Each of the LCs 603-1 to 603-m receives, as the reference signal level, the level specified by the LD 113 having the corresponding branch number as the LC 603 among the LDs 113-1 to 113-m and controls the level of the band second source sound data passed from the BPF 602 having the corresponding branch number as the LC 603 among the BPFs 602-1 to 602-m so that the level converges to the target gain corresponding to the reference signal level represented by the preset gain specification function GR at the response speed represented by the preset time constant TC.

The time constant TC set in the LC 603 is set to a greater value than the time constant TC set in the LC 117. Since the environmental sound creates the background noise in the space to mask, it is not necessary to change the level of the environmental sound promptly following the change of the level of the voice to mask when compared with the masking sound having the obfuscated voice as the source thereof. When the level of the environmental sound changes a little at a time promptly following the change of the level of the voice to mask, this increases unpleasant feelings of a listener unnecessarily and thus is not desirable.

The masking sound generating system 6 having the above configuration emits the obfuscated voice and the masking sound to which the environmental sound is added. At this time, the level of the obfuscated voice and the environmental sound is changed for each frequency band depending on the level of the voice of the speaker A according to different parameters (time constants TC). As a result, the masking sound generating system 6 emits a masking sound having high masking efficiency and giving less unpleasantness to a listener.

### 2.6. Sixth Modification Example

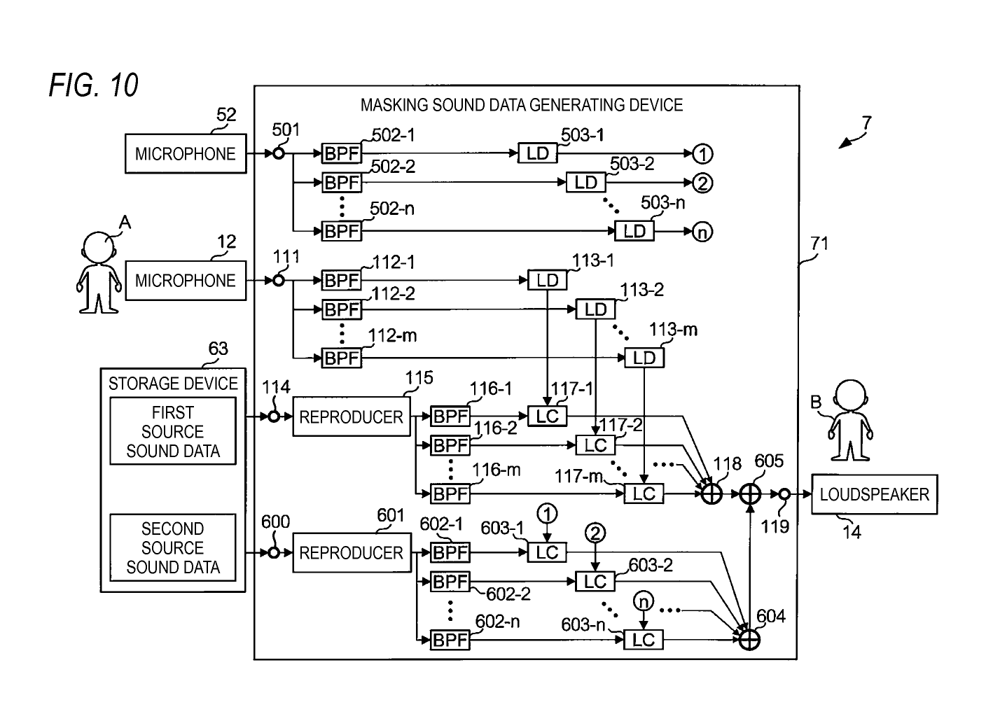

FIG. 10 is a block diagram illustrating the configuration of a masking sound generating system 7 according to a sixth modification example. The masking sound generating system 7 is configured by combining the configuration (FIG. 8) of the masking sound generating system 5 in the fourth modification example and the configuration (FIG. 9) of the masking sound generating system 6 in the fifth modification example described previously above. Accordingly, in FIG. 10, the same reference signs are given to the units that are the same as the configurational units of the masking sound generating system 5 or the masking sound generating system 6.

The masking sound generating system 7, in the same manner as the masking sound generating system 5, includes the microphone 52 receiving the background noise in the space where the speaker A (or the listener B) is present. In addition, the masking sound generating system 7 includes a masking sound data generating device 71 instead of the masking sound data generating device 11 provided in the masking sound generating system 1. The masking sound data generating device 71, similarly to the masking sound data generating device 51, includes the input IF 501, which receives the input of the background noise data from the microphone 52, the BPFs 502-1 to 502-n, which divide the background noise data input from the microphone 52 through the input IF 501 into n pieces of band background noise data, and the LDs 503-1 to 503-n, which correspond to each of the BPFs 502-1 to 502-n and specify the level of the band background noise data.

The masking sound generating system 7, in the same manner as the masking sound generating system 6, further includes the storage device 63 which stores the first source sound data representing the voice for which the obfuscating process is performed and the second source sound data representing the environmental sound. In addition, the masking sound data generating device 71, in the same manner as the masking sound data generating device 61, includes the input IF 600, which receives the input of the second source sound data stored in the storage device 63, the reproducer 601, which reproduces the second source sound data, the multiple pieces of the BPF 602, which divide the second source sound data into multiple pieces of the band second source sound data, and the multiple pieces of the LC 603, which correspond to these pieces of the BPF 602 and adjust the level of the band second source sound data. The number of pieces of the BPF 602 and the LC 603 provided in the masking sound data generating device 71 is n and is different from that in the masking sound data generating device 61.

Each of the LCs 603-1 to 603-n of the masking sound data generating device 71 receives, as the reference signal level, the level specified by the LD 503 having the corresponding branch number as the LC 603 among the LDs 503-1 to 503-n. That is to say, the LCs 603-1 to 603-n receives the level of the band background noise data as the reference signal level and changes the level of the second source sound data representing the environmental sound for each frequency band.

The masking sound data generating device 71, similarly to the masking sound data generating device 61, further includes the adder 604, which generates environmental sound data by adding the pieces of band second source sound data of which the level is changed by the LCs 603-1 to 603-n, and the adder 605, which generates the masking sound data representing a masking sound giving less unpleasantness by adding the masking sound data generated by the adder 118 and the environmental sound data generated by the adder 604. The adder 605 outputs the generated masking sound data to the loudspeaker 14 through the output IF 119.

Accordingly, the masking sound generating system 7 having the above configuration emits an obfuscated voice and a less unpleasant masking sound to which the environmental sound is added. At this time, the obfuscated voice is adjusted for each frequency band depending on the level of the voice of the speaker A, and the environmental sound is adjusted for each frequency band depending on the level of the background noise, independently of the adjustment depending on the level of the voice of the speaker A. As a result, high masking efficiency is obtained by emitting the obfuscated voice of which the level changes following the level of the voice to mask, and the background noise and the environmental sound are naturally mixed by emitting the environmental sound of which the level changes following the level of the background noise. Thus, sound masking is performed with less unpleasantness for a listener.

### 2.7. Seventh Modification Example

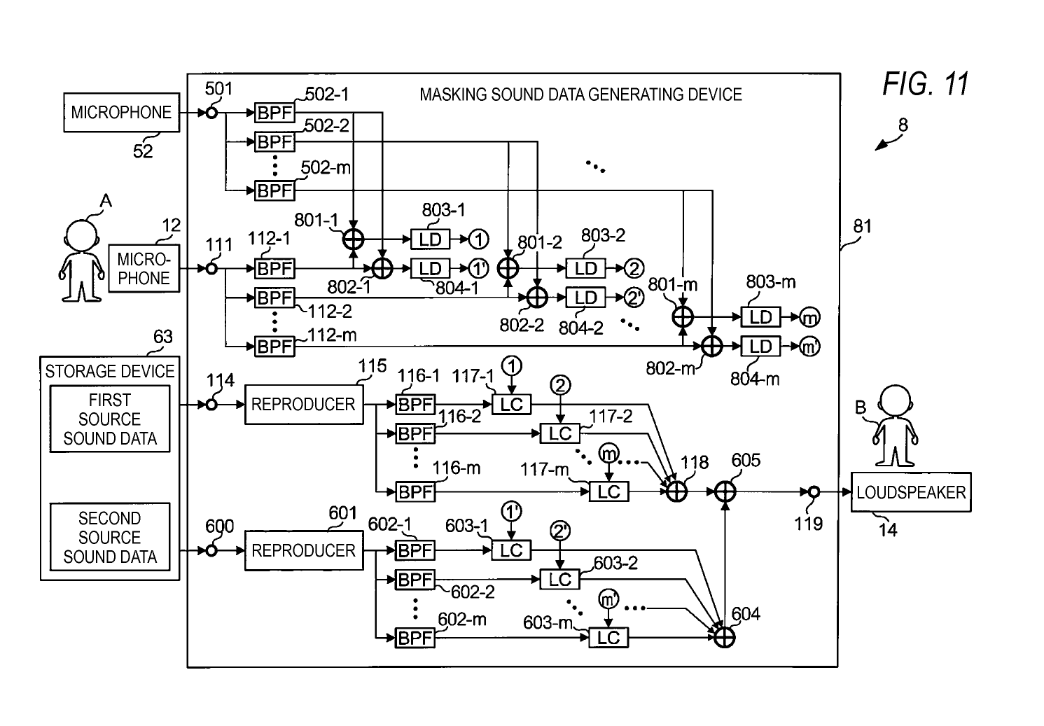

FIG. 11 is a block diagram illustrating the configuration of a masking sound generating system 8 according to a seventh modification example. The configuration of the masking sound generating system 8 is similar to the configuration (FIG. 10) of the masking sound generating system 7 and is a combination of the configuration (FIG. 8) of the masking sound generating system 5 in the fourth modification example and the configuration (FIG. 9) of the masking sound generating system 6 in the fifth modification example described previously above. Accordingly, in FIG. 11, in the same manner as FIG. 10, the same reference signs are given to the units that are the same as the configurational units of the masking sound generating system 5 or the masking sound generating system 6.

The masking sound generating system 8 generates a masking sound by changing the level of each of the obfuscated voice (first source sound data) and the environmental sound (second source sound data) for each frequency band depending on the level of the sound obtained from the addition of the voice of the speaker A and the background noise for each frequency band and adding the obfuscated voice and the environmental sound of which the level is changed. The ratio of the level in adding the voice of the speaker A and the background noise is individually set for a use to change the level of the obfuscated voice and a use to change the level of the environmental sound.

To realize the above function, the masking sound generating system 8, in the same manner as the masking sound generating system 7, includes the microphone 52, which receives the background noise, and the storage device 63, which stores the first source sound data and the second source sound data. In addition, the masking sound generating system 8 includes a masking sound data generating device 81 instead of the masking sound data generating device 11 provided in the masking sound generating system 1. The masking sound data generating device 81, in the same manner as the masking sound data generating device 71, includes the input IF 501 and the multiple pieces of the BPF 502 for processing the background noise data generated by the microphone 52. The number of the BPF 502 provided in the masking sound data generating device 81 is m.

The masking sound data generating device 81 includes adders 801-1 to 801-m and adders 802-1 to 802-m that add the band speaker sound data generated by the BPFs 112-1 to 112-m and the band background noise data generated by the BPFs 502-1 to 502-m for each same frequency band. That is to say, each of the adders 801-1 to 801-m adds the band speaker sound data generated by the BPF 112 having the corresponding branch number as each of the adders 801-1 to 801-m among the BPFs 112-1 to 112-m and the band background noise data generated by the BPF 502 having the corresponding number as each of the adders 801-1 to 801-m among the BPFs 502-1 to 502-m. In the same manner, each of the adders 802-1 to 802-m adds the band speaker sound data generated by the BPF 112 having the corresponding branch number as each of the adders 801-1 to 801-m among the BPFs 112-1 to 112-m and the band background noise data generated by the BPF 502 having the corresponding branch number as each of the adders 801-1 to 801-m among the BPFs 502-1 to 502-m. The ratio of the level in adding the band speaker sound data and the band background noise data is individually set in each of the adders 801-1 to 801-m. In the same manner, the ratio of the level in adding the band speaker sound data and the band background noise data is individually set in each of the adders 802-1 to 802-m.

The masking sound data generating device 81 includes LDs 803-1 to 803-m instead of the LDs 113-1 to 113-m provided in the masking sound data generating device 11. The LDs 803-1 to 803-m specify the level of the sound data obtained from the addition by the adders 801-1 to 801-m. The level specified by the LDs 803-1 to 803-m is passed to the LCs 117-1 to 117-m as the reference signal level and is used in changing of the level of the band source sound data divided from the first source sound data (sound data representing the obfuscated voice).

The masking sound data generating device 81 further includes LDs 804-1 to 804-m that specify the level of the sound data generated from the addition by the adders 802-1 to 802-m. The level specified by the LDs 804-1 to 804-m is passed to the LCs 603-1 to 603-m as the reference signal level and is used in changing of the level of the band second source sound data divided from the second source sound data (sound data representing the environmental sound).

The pieces of band source sound data of which the level is changed by the LCs 117-1 to 117-m are added by the adder 118 and become the masking sound data. The pieces of band second source sound data of which the level is changed by the LCs 603-1 to 603-m are added by the adder 604 and become the environmental sound data. The masking sound data generated by the adder 118 and the environmental sound data generated by the adder 604 are added by the adder 605 and are output to the loudspeaker 14 through the output IF 119.

The masking sound data generating device 81 having the above configuration divides the band of the speaker sound data generated by the microphone 12 and the background noise data generated by the microphone 52 and adds the divided pieces of data for each frequency band. Instead, the masking sound data generating device 81 may be configured to add the speaker sound data and the background noise data first prior to the band division and then divide the band thereof. In this case, the ratio of the level cannot be set individually for each frequency band in the addition, but the number of adders can be decreased when compared with the configuration illustrated in FIG. 11. This process can further simplify the configuration of the masking sound data generating device 81 and reduce a processing load.

The masking sound generating system 8 having the above configuration emits the obfuscated voice and the masking sound to which the environmental sound is added. At this time, the ratio of the level of the voice of the speaker A and the background noise in the sound obtained from the addition of the voice of the speaker A and the background noise, the ratio being referred to in changing of the level of the obfuscated voice, is in accordance with the ratio of the level set individually for each frequency band. Accordingly, adjusting the setting of these ratios of the level can adjust a balance between the extent of the level of the obfuscated voice included in the masking sound changing depending on the level of the voice of the speaker A and the extent thereof changing depending on the level of the background noise for each frequency band. In addition, the ratio of the level of the voice of the speaker A and the background noise in the sound obtained from the addition of the voice of the speaker A and the background noise, the ratio being referred to in changing of the level of the environmental sound, is also in accordance with the ratio of the level set individually for each frequency band. Accordingly, adjusting the setting of these ratios of the level can adjust a balance between the extent of the level of the environmental sound included in the masking sound changing depending on the level of the voice of the speaker A and the extent thereof changing depending on the level of the background noise for each frequency band. As a result, the masking sound generating system 8 can emit a masking sound having a balance between two points of masking efficiency and reducing of unpleasantness to a listener.

### 2.8. Eighth Modification Example

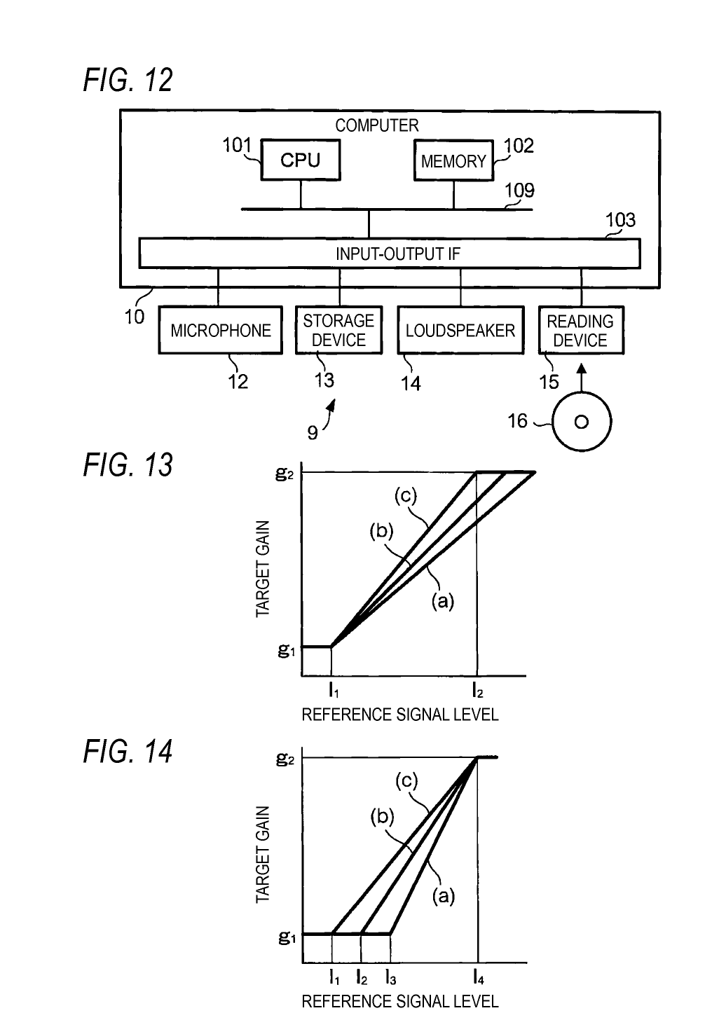

In an eighth modification example, a computer performs processes in accordance with a program to operate as the masking sound data generating device 11 having the configuration illustrated in FIG. 1. FIG. 12 is a block diagram illustrating the configuration of a masking sound generating system 9 according to an eighth modification example.

The masking sound generating system 9 includes a computer 10 instead of the masking sound data generating device 11 provided in the masking sound generating system 1. The computer 10 is a general computer and includes a CPU 101, a memory 102, and an input-output IF 103. The CPU 101 performs various operations according to a BIOS, an OS, application programs, and the like and controls other configurational units. The memory 102 includes a ROM, a RAM, a hard disk, an SSD, or the like that stores various pieces of data such as the BIOS, the OS, application programs, and user data. The input-output IF 103 inputs and outputs data to external devices. The CPU 101, the memory 102, and the input-output IF 103 are connected to each other through a bus 109. The microphone 12, the storage device 13, the loudspeaker 14, and a reading device 15 are connected to the input-output IF 103 as external devices.

The reading device 15 is a device that reads an application program according to the present modification example (referred to simply as an “application program” hereinafter) from a recording medium 16 on which the application program is recorded. The recording medium 16 is a non-volatile recording medium on which data can be recorded by the computer 10 through the reading device 15 and, for example, may be any of a CD-ROM, a DVD-ROM, a flash memory, and the like.

The CPU 101, in accordance with a program stored in the memory 102, instructs the reading device 15 to read the application program from the recording medium 16 mounted in the reading device 15 in response to the operation by a user using, for example, a keyboard and the like (not illustrated) connected to the input-output IF 103. The application program read from the recording medium 16 by the reading device 15 in accordance with this instruction is passed to the memory 102 through the input-output IF 103 and is stored in the memory 102.

The CPU 101 thereafter processes various pieces of data according to the application program stored in the memory 102. Thus, the computer 10 functions as the masking sound data generating device 11 having the configuration illustrated in FIG. 1. That is to say, the application program that is stored in the recording medium 16 and is read to be used by the computer 10 is a program required for a computer to perform the processes of each of the configurational units provided in the masking sound data generating device 11.

The CPU 101 may be configured to perform processes according to any of application programs corresponding to the first modification example to the seventh modification example so that the computer 10 functions as any of the masking sound data generating device 21 to the masking sound data generating device 81 illustrated in FIG. 5 to FIG. 11. In the above configuration in the present modification, the CPU 101 reads the application program from the memory 102 when performing processes according to the application program, the application program being copied to the memory 102 from the recording medium 16. Instead, the CPU 101 may configured to read the application program recorded on the recording medium 16 through the reading device 15 when performing processes according to the application program. In addition, instead of reading the application program from the recording medium 16 through the reading device 15, the computer 10 may be configured to receive the application program from a device storing the application program through a network, store the application program on the memory 102, and use the application program.

### 2.9. Other Modification Examples

Modifications may be further carried out to the embodiment or the modification examples described above.

(1) The masking sound data generating device 11 according to the embodiment generates the masking sound data by setting the level of m pieces of band source sound data obtained from the division of the band of the source sound data to correspond respectively to the level of m pieces of band speaker sound data obtained from the division of the band of the speaker sound data and adding the source sound data and the speaker sound data. The number of pieces of band source sound data used in the generation of the masking sound data by the masking sound data generating device 11 may be any number greater than or equal to two. In addition, two or more of different frequency bands of the band source sound data used in the generation of the masking sound data by the masking sound data generating device 11 do not need to be continuous without a gap. There may be a gap or an overlapping part therebetween. The number and the arrangement of bands are also not limited for the case of the band source sound data and the band speaker sound data in the first modification example to the seventh modification example and the band background noise data in the fourth modification example, the sixth modification example, or the seventh modification example provided that these pieces of data are sound data having two or more of different frequency bands.

(2) The masking sound data generating device 11 according to the embodiment and the masking sound data generating device 21 to the masking sound data generating device 51 according to the first modification example to the fourth modification example generate the masking sound data having different characteristics by variously changing the parameters (the gain specification function GR and the time constant TC) set in the level controllers (the LC 117 and the LC 505) provided therein. In addition, the masking sound data generating device 61 to the masking sound data generating device 81 according to the fifth modification example to the seventh modification example generate the masking sound data having different characteristics by variously changing the parameters (the gain specification function GR and the time constant TC) set in the level controllers (the LC 117 and the LC 603) and the parameters (the ratio of the level in the addition) set in the adders provided therein.

The masking sound data generating device 11 to the masking sound data generating device 81 (referred to collectively as a “masking sound data generating device” hereinafter) may be configured to generate the masking sound data by preparing multiple combinations of the parameters in advance as templates, storing the templates on, for example, the storage device 13, the storage device 23, or the storage device 63, allowing a user to select a template that the user thinks is desirable in view of, for example, audibility and masking efficiency, and setting the parameters according to the template selected by the user.

(3) The microphone 12 is intended to receive the voice of the speaker A but also receives the background noise in the space where the speaker A is present at the same time. Accordingly, when, for example, a loud noise is emitted near the speaker A, the level of the masking sound data generated by the masking sound data generating device receives the influence of the level of the noise. The influence is particularly greater in a frequency band for which a small time constant TC is set. When the level of a noise and the like other than the voice is input as the reference signal level into the level controller that is set with the parameters so as to change the level with the level of the voice as the reference signal level, the masking sound data resulting therefrom may represent a masking sound which is not desirable. To avoid such a problem, for example, the masking sound data generating device may include a filter (frequency characteristics adjusting portion such as an equalizer) that performs signal processing for the speaker sound data input from the microphone 12 through the input IF 111 or each of the pieces of band speaker sound data obtained after the division of the band of the speaker sound data by the BPF 112 so as to reduce non-voice components of sounds included in the sound represented by the speaker sound data or the band speaker sound data.

(4) In the embodiment and the modification examples described above, the microphone 12 (and the microphone 52), the storage device 13 (or the storage device 23 or the storage device 63), and the loudspeaker 14 are connected to the masking sound data generating device as external devices. However, at least one of these devices may be incorporated into the masking sound data generating device. In addition, the microphone 12 (and the microphone 52), the storage device 13 (or the storage device 23 or the storage device 63), and the loudspeaker 14 may be connected to the masking sound data generating device in a wired or a wireless manner and may be connected thereto directly or through a network.

(5) Two or more of the configurational units provided in the masking sound data generating device according to the embodiment or the modification examples described above may be configured as one combined configurational unit. While, for example, the LDs 113-1 to 113-m and the LCs 117-1 to 117-m provided in the masking sound data generating device 11 are described as individual devices, each of the LDs 113-1 to 113-m and the LC 117 having the corresponding branch number among the LCs 117-1 to 117-m may be configured as one combined circuit. In addition, one configurational unit provided in the masking sound data generating device according to the embodiment or the modification examples described above may be configured as an aggregate of two or more configurational units cooperating with each other.

(6) In the embodiment or the modification examples described above, a part of the configurational unit incorporated into the masking sound data generating device may be configured as a device that is connected to the masking sound data generating device externally. For example, the reproducer 115 provided in the masking sound data generating device 11 may be connected to the masking sound data generating device 11 as an external device.

(7) The masking sound data generating device according to the embodiment or the modification examples described above uses the level of the envelope of the band speaker sound data or the band background noise data as the reference signal level input to the level controllers. However, any index such as the average value of a power spectrum may be used as the reference signal level provided that the index indicates the magnitude of the level of the band speaker sound data or the band background noise data.

(8) The number of configurational units provided in the masking sound generating systems 1 to 9 according to the embodiment or the modification examples described above and the number of pieces of data processed by these configurational units can be changed arbitrarily. For example, the number of the microphone 12 and the microphone 52 may be configured to be greater than or equal to two so as to perform various processes for the sound received by each microphone. Alternatively, the storage device 13 may be configured to store multiple pieces of source sound data, the storage device 23 to store multiple sets of band source sound data, or the storage device 63 to store multiple pieces of first source sound data and multiple pieces of second source sound data so as to perform various processes for these pieces of data individually.

(9) A part of the order of the data processing adopted in the embodiment or the modification examples described above may be replaced with another order that obtains the same or a similar result. For example, any method of adding sound data after performing band division and performing band division after adding sound data prior to the band division may be adopted provided that the pieces of data obtained through these methods are the same or similar to each other.

(10) In the fourth modification example, the sixth modification example, and the seventh modification example described above, the background noise included in the sound (including the voice of the speaker A mainly) received by the microphone 12 may be configured to be used after extracted through, for example, a known filtering process instead of using the background noise received by using the microphone 52.

(11) There is no limitation on the place where the masking sound data generating device and the storage device 13 (or the storage device 23 or the storage device 63) are arranged. For example, the masking sound data generating device may be arranged in the space where the speaker A is present (or the space where the listener B is present), and the storage device 13 (or the storage device 23 or the storage device 63) may be arranged through a network at a place that is geologically separate from the space where the speaker A is present or the space where the listener B is present. In this case, the masking sound data generating device may use the source sound data stored in the storage device 13 (or the band source sound data stored in the storage device 23 or the first source sound data and the second source sound data stored in the storage device 63) by downloading the data completely to, for example, the memory 102 prior to the start of the generation of the masking sound data or may use the source sound data by receiving a necessary part thereof sequentially from the storage device 13 (or the storage device 23 or the storage device 63) concurrently with the generation of the masking sound data.

In addition to the storage device 13 (or the storage device 23 or the storage device 63), for example, the masking sound data generating device may also be arranged through a network at a place that is geologically separate from the space where the speaker A is present and the space where the listener B is present. In this case, the speaker sound data generated by the microphone 12 (and the background noise data generated by the microphone 52) is transmitted to the masking sound data generating device through a network and is used in the generation of the masking sound data. In addition, the masking sound data generated by the masking sound data generating device is transmitted to the loudspeaker 14 through a network and is used in the emission of the masking sound.

(12) In the embodiment or the modification examples described above, the gain specification function GR and the time constant TC are set in each of the level controllers (the LC 117, the LC 505, and the LC 603) as the parameters for specifying a rule for changing the level of the band source sound data (or the band second source sound data). Each of the level controllers change the level so as to obtain the target gain specified according to the gain specification function GR depending on the level of the band speaker sound data or the band background noise data specified by the level detector circuits (the LD 113, the LD 503, the LD 803, and the LD 804) at the response speed represented by the time constant TC. The rule for changing the level of the band source sound data (or the band second source sound data) by the level controllers is not limited to this. Other various rules may be adopted provided that the rule specifies the level of the source data (or the band second source sound data) after the change thereof on the basis of the level specified by the level detector circuits.

Each of the level controllers, for example, may be configured to change the level by being individually set with only the gain specification function GR as a parameter so as to obtain the target gain at the same response speed for all of the level controllers. In addition, each of the level controllers may be configured to change the level by being individually set with only the time constant TC as a parameter so as to obtain the target gain specified according to the same gain specification function GR for all of the level controllers at the response speed represented by the individually set time constant TC.

Each of the level controllers, instead of the gain specification function GR, for example, may be configured to change the level of the band source sound data (or the band second source sound data) by being set with, as a parameter, a function or a correspondence table representing the gain (or the increment or the like of the level) of the band source sound data (or the band second source sound data) corresponding to the band speaker sound data (or the band background noise data) so as to obtain the gain (or the increment or the like of the level) specified according to the function or the correspondence table at the response speed represented by the time constant TC (or at the response speed represent by the same time constant for all of the level controllers).

(13) The gain specification function GR is apparently not limited to those illustrated in FIGS. 2 to 4. To make sure of this, other variations on the gain specification function GR are illustrated in FIGS. 13 to 16.

The graphs (a) to (c) in FIG. 13 have a lower limit and an upper limit of the target gain. The graphs (a) to (c) output the constant value g₁ as a target gain regardless of the magnitude of the reference signal level when the reference signal level is less than or equal to I₁ and output the constant value g₂ as the target gain regardless of the magnitude of the reference signal level when the reference signal level is greater than or equal to I₂ (I₁<I₂). However, when the reference signal level is between I₁ and I₂, the inclination of the increment of the target gain with respect to the increment of the reference signal level is different for the graphs (a) to (c) such that the inclination of the graph (a)<the inclination of the graph (b)<the inclination of the graph (c). Thus, different values of the target gain are output by each of the graphs (a) to (c).

The graph (a) in FIG. 14 has a lower limit of the target gain. When the reference signal level is less than or equal to I₃, the constant value g₁ is output as a target gain regardless of the magnitude of the reference signal level. The graph (b) also has a lower limit of the target gain. When the reference signal level is less than or equal to I₂ (I₂<I₃), the constant value g₁ is output as a target gain regardless of the magnitude of the reference signal level. The graph (c) also has a lower limit of the target gain. When the reference signal level is less than or equal to I₁ (I₁<I₂), the constant value g₁ is output as a target gain regardless of the magnitude of the reference signal level. In addition, the graphs (a) to (c) have an upper limit of the target gain. When the reference signal level is greater than or equal to I₄ (I₃<I₄), the constant value g₂ is output as a target gain regardless of the magnitude of the reference signal level. However, when the reference signal level is between I₁ and I₄, the inclination of the increment of the target gain with respect to the increment of the reference signal level is different for the graphs (a) to (c) such that the inclination of the graph (a)>the inclination of the graph (b)>the inclination of the graph (c). Thus, different values of the target gain are output by each of the graphs (a) to (c).

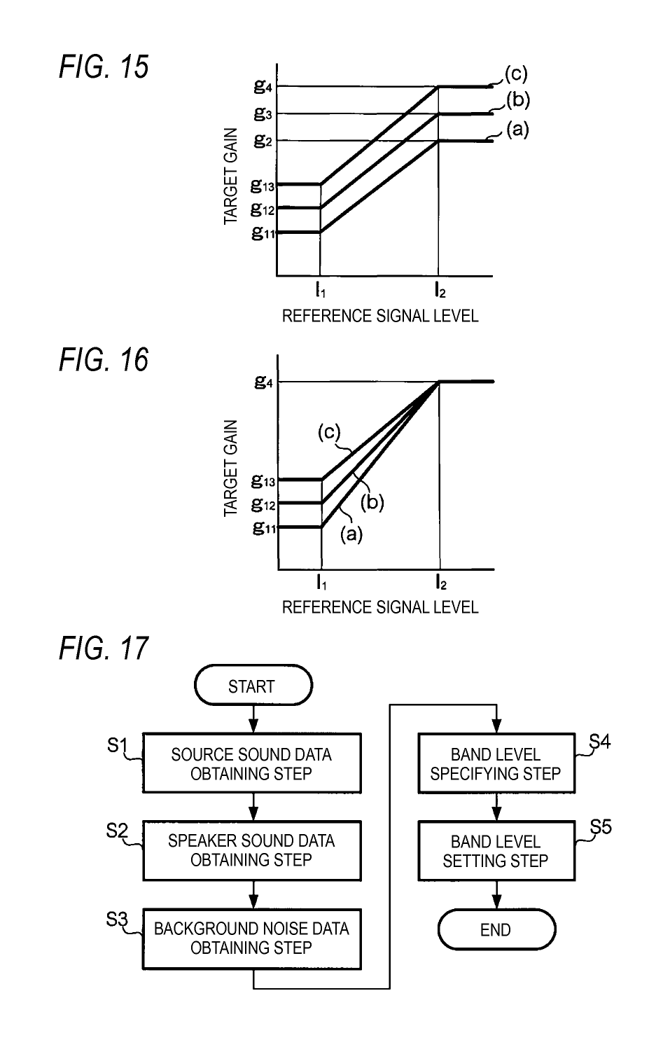

The graphs (a), (b), and (c) in FIG. 15 have a lower limit and an upper limit of the target gain. The graphs (a), (b), and (c) respectively output constant values g₁₁, g₁₂, and g₁₃ (g₁₁<g₁₂<g₁₃) as a target gain regardless of the magnitude of the reference signal level when the reference signal level is less than or equal to I₁ and respectively output the constant values g₂, g₃, and g₄ (g₁₃<g₂<g₃<g₄) as a target gain regardless of the magnitude of the reference signal level when the reference signal level is greater than or equal to I₂ (I₁<I₂). When the reference signal level is between I₁ and I₂, the increment of the target gain with respect to the increment of the reference signal level of the graphs (a), (b), and (c) is the same.

The graphs (a), (b), and (c) in FIG. 16 have a lower limit and an upper limit of the target gain. The graphs (a), (b), and (c) respectively output the constant values g₁₁, g₁₂, and g₁₃ (g₁₁<g₁₂<g₁₃) as a target gain regardless of the magnitude of the reference signal level when the reference signal level is less than or equal to I₁ and output the constant value g₄ (g₁₃<g₄) as a target gain regardless of the magnitude of the reference signal level when the reference signal level is greater than or equal to I₂ (I₁<I₂). When the reference signal level is between I₁ and I₂, the inclination of the increment of the target gain with respect to the increment of the reference signal level is different for the graphs (a) to (c) such that the inclination of the graph (a)>the inclination of the graph (b)>the inclination of the graph (c). Thus, different values of the target gain are output by each of the graphs (a) to (c).

It is apparent that any of the gain specification functions GR illustrated in each of the FIGS. 2 to 4 and FIGS. 13 to 16 may be combined. For example, the gain specification function GR of the graph (a) in FIG. 2 is set as the level change parameter in the LC 117 of a frequency band for less significant information in the voice of which the transmission is to be impeded, and the gain specification function GR of the graph (c) in FIG. 3 is set as the level change parameter in the LC 117 of a frequency band for more significant information in the voice of which the transmission is to be impeded. In addition, the masking sound data generating devices 11 to 81 may appropriately select the gain specification functions GR described above depending on characteristics of a speaker or the voice of a speaker. Characteristics of a speaker or the voice of a speaker used at this time may be any characteristics such as the sex and the age of a speaker, the language of the voice of a speaker, the speech rate of the voice of a speaker, the pitch of the voice of a speaker, and the volume of the voice of a speaker.

The masking sound data generating devices 11 to 81 may select any gain specification function GR from the gain specification functions GR having common characteristics (for example, the graphs (a) to (c) in FIG. 2 have common characteristics such as an area where the reference signal level and the target gain have a proportional relationship) among the gain specification functions GR illustrated in each of FIGS. 2 to 4 and FIGS. 13 to 16 and set the selected gain specification function GR as a level change parameter. In addition, the masking sound data generating devices 11 to 81 may select any gain specification function GR from the gain specification functions GR having few common characteristics (that is, any gain specification function GR from across each of FIGS. 2 to 4 and FIGS. 13 to 16) and set the selected gain specification function GR as a level change parameter.

As described above, in the present invention, the band level setting portion sets the level of the frequency band of the source sound data for each of two or more frequency bands according to a predetermined rule on the basis of the level of those frequency band of the speaker sound data and generates the masking sound data representing the masking sound. A predetermined rule here includes a rule for setting any of the gain specification functions GR having various characteristics as the level change parameter as described above.

(14) In the present invention, the band level setting portion sets the level of at least the two frequency bands of the source sound data so that the predetermined rule has a different response speed for at least two frequency bands among two or more frequency bands until reaching a convergent value corresponding to each level of at least the two frequency bands of the speaker sound data. The time constants TC-1 to TC-m (that is, numerical values representing the response speed of the gain in the changing of the level by the LCs 117-1 to 117-m until converging to the target gain determined by the gain specification functions GR-1 to GR-m) described above are used as “the predetermined rule having a different response speed for each level of at least the two frequency bands of the speaker sound data until reaching a convergent value”.

A delay time (amount of a delay) from the input of the speaker sound data into the level controllers (the LC 117, the LC 505, and the LC 603) until the outputting of the source sound data from the level controllers (the LC 117, the LC 505, and the LC 603) may be used instead of the time constants TC-1 to TC-m. For example, each of the LCs 117-1 to 117-m in FIG. 1 stores delay times DL-1 to DL-m on the memory as a level change parameter set in each of the LCs 117-1 to 117-m in addition to the gain specification functions GR-1 to GR-m described above. Each of the LCs 117-1 to 117-m outputs the source sound data to the adder 118 at the point in time after the passage of the delay times DL-1 to DL-m set in each of the LCs 117-1 to 117-m when the source sound data is output from the level controllers (the LC 117, the LC 505, and the LC 603). That is to say, the delay times DL-1 to DL-m mean a time taken until the band source sound data corresponding to the target gain determined by the gain specification functions GR-1 to GR-m is output, that is, the response speed of the gain until reaching the target gain that is output according to the gain specification function GR depending on the input reference signal level. At least two of the delay times DL-1 to DL-m stored in each of the LCs 117-1 to 117-m are different from each other so as to obtain the desirable masking sound data. The delay times DL-1 to DL-m, for example, are a time of approximately half of one phoneme (generally 50 msec to 200 msec) in the case of the Japanese language. When the delay time is optimized for each frequency band of the speaker sound data, it can be expected that the accent of the sound of a speaker is smoothed and equalized temporally. Such delaying may be performed only for the significant frequency band described above.

(15) The operation of the masking sound data generating device 51 will be described as an example of an outline of the operation of the masking sound data generating devices 11 to 81 by using FIG. 17. In FIG. 17, the order between steps S1 and S3 is not limited to the order illustrated in FIG. 17 and may be arbitrary. In addition, at least two steps among these may be performed concurrently. In step S1, the masking sound data generating device 51 obtains the source sound data representing the sound used in the generation of the masking sound data (source sound data obtaining step). In step S2, the masking sound data generating device 51 obtains the speaker sound data representing the voice of a speaker which is a masking target (speaker sound data obtaining step). In step S3, the masking sound data generating device 51 obtains the background noise data representing the background noise (background noise data obtaining step). In step S4, the masking sound data generating device 51 specifies the level of each of two or more frequency bands in the speaker sound data (band level specifying step). In step S5, the masking sound data generating device 51 generates the masking sound data representing the masking sound by setting, for each of two or more frequency bands, the level of the frequency band of the source sound data according to a predetermined rule on the basis of the level of the frequency band of the speaker sound data specified by the band level specifying portion (band level setting step). In step S5, the masking sound data generating device 51 sets the level of each of at least two frequency bands among two or more frequency bands in the source sound data according to different predetermined rules.

An outline of the operation of the masking sound data generating devices 11 to 41 and 61 to 81 without the masking sound data generating device 51 is the same as that illustrated in FIG. 17 except the background noise data obtaining step of step S3.

The present invention may be realized through such methods described above.

Here, the details of the above embodiments are summarized as follows.

(1) There is provided a masking sound data generating device comprising:

a source sound data obtaining portion that obtains source sound data which represents a sound used in a generation of masking sound data;

a speaker sound data obtaining portion that obtains speaker sound data which represents a voice of a speaker which is a masking target;

a band level specifying portion that specifies each level of two or more frequency bands in the speaker sound data; and

a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound,

wherein the band level setting portion sets each level of at least two frequency bands among from the two or more frequency bands in the source sound data in accordance with the predetermined rules which are different to each other.

(2) For example, the band level setting portion sets each level of the at least two frequency bands among from the two or more frequency bands in the source sound data in accordance with the predetermined rules having different relationships between each level of the at least two frequency bands in the speaker sound data specified by the band level specifying portion and a gain relating to the levels of the source sound data, and the gain relating to the levels of the source sound data is a ratio of each level of the at least two frequency bands in the source sound data after the setting to each level thereof before the setting.

(3) For example, the band level setting portion sets each level of the at least two frequency bands among from the two or more frequency bands in the source sound data in accordance with the predetermined rules having different response speeds until reaching a convergent value corresponding to each level of the at least two frequency bands in the speaker sound data specified by the band level specifying portion.

(4) For example, the masking sound data generating device further includes:

a background noise data obtaining portion that obtains background noise data which represents a background noise,

wherein the band level specifying portion specifies each level of two or more frequency bands in the background noise data; and

wherein the band level setting portion sets each level of two or more frequency bands in the source sound data, corresponding to the two or more frequency bands in the background noise data, in accordance with a predetermined rule on the basis of the each level of the frequency bands in the background noise data specified by the band level specifying portion in the generation of the masking sound data.

(5) There is provided a method for generating masking sound data, comprising:

obtaining source sound data which represents a sound used in a generation of masking sound data;

obtaining speaker sound data which represents a voice of a speaker which is a masking target;

specifying each level of two or more frequency bands in the speaker sound data; and

setting each level of two or more frequency bands in the source sound data, corresponding to the two or more frequency bands in the speaker sound data, in accordance with predetermined rules on the basis of the each level of the frequency bands in the speaker sound data specified by a process of the specifying to generate masking sound data which represents a masking sound,

wherein in a process of the setting, each level of at least two frequency bands among from the two or more frequency bands in the source sound data is set in accordance with the predetermined rules which are different to each other.

(6) For example, in the process of the setting, each level of the at least two frequency bands in the source sound data is set in accordance with the predetermined rules having different relationships between each level of the at least two frequency bands in the speaker sound data specified by the process of the specifying and a gain relating to the levels of the source sound data, and the gain relating to the levels of the source sound data is a ratio of each level of the at least two frequency bands in the source sound data after the setting to each level thereof before the setting.

(7) For example, in the process of the setting, each level of the at least two frequency bands among from the two or more frequency bands in the source sound data is set in accordance with the predetermined rules having different response speeds until reaching a convergent value corresponding to each level of the at least two frequency bands in the speaker sound data specified by the process of the specifying.

(8) For example, the masking sound data generating method further includes:

obtaining background noise data which represents a background noise; and

specifying each level of two or more frequency bands in the background noise data,

wherein in the process of the setting, each level of two or more frequency bands in the source sound data, corresponding to the two or more frequency bands in the background noise data, is set in accordance with a predetermined rule on the basis of the each level of the frequency bands in the background noise data specified by the band level specifying portion in the generation of the masking sound data.

(9) There is provided a masking sound generating system comprising:

a sound receiving device that generates speaker sound data by receiving a voice of a speaker which is a masking target and outputs the speaker sound data;

a masking sound data generating device that generates masking sound data representing a masking sound; and

a sound emitting device that emits the masking sound data generated by the masking sound data generating device as the masking sound,

wherein the masking sound data generating device comprises:
a source sound data obtaining portion that obtains source sound data that represents a sound used in the generation of the masking sound data;
a speaker sound data obtaining portion that obtains the speaker sound data which is output from the sound receiving device;
a band level specifying portion that specifies each level of two or more frequency bands in the speaker sound data;
a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound; and
an outputting portion that outputs the masking sound data generated by the band level setting portion to the sound emitting device; and

wherein the band level setting portion sets each level of at least two frequency bands among from the two or more frequency bands in the source sound data in accordance with the predetermined rules which are different to each other.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2014-046805 filed on Mar. 10, 2014, and contents of which are incorporated herein by reference.

What is claimed is:

1. A masking sound data generating device comprising:
a source sound data obtaining portion that obtains source sound data which represents a sound used in a generation of masking sound data;
a speaker sound data obtaining portion that obtains speaker sound data which represents a voice of a speaker which is a masking target;
a band level specifying portion that specifies each level of two or more frequency bands in the speaker sound data; and
a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound,
wherein the band level setting portion sets each level of at least two frequency bands among from the two or more frequency bands in the source sound data in accordance with the predetermined rules which are different to each other.

2. The masking sound data generating device according to claim 1, wherein the band level setting portion sets each level of the at least two frequency bands among from the two or more frequency bands in the source sound data in accordance with the predetermined rules having different relationships between each level of the at least two frequency bands in the speaker sound data specified by the band level specifying portion and a gain relating to the levels of the source sound data; and
wherein the gain relating to the levels of the source sound data is a ratio of each level of the at least two frequency bands in the source sound data after the setting to each level thereof before the setting.

3. The masking sound data generating device according to claim 1,
wherein the band level setting portion sets each level of the at least two frequency bands among from the two or more frequency bands in the source sound data in accordance with the predetermined rules having different response speeds until reaching a convergent value corresponding to each level of the at least two frequency bands in the speaker sound data specified by the band level specifying portion.

4. The masking sound data generating device according to claim 1, further comprising:
a background noise data obtaining portion that obtains background noise data which represents a background noise,
wherein the band level specifying portion specifies each level of two or more frequency bands in the background noise data; and
wherein the band level setting portion sets each level of two or more frequency bands in the source sound data, corresponding to the two or more frequency bands in the background noise data, in accordance with a predetermined rule on the basis of the each level of the frequency bands in the background noise data specified by the band level specifying portion in the generation of the masking sound data.

5. A method for generating masking sound data, comprising:
obtaining source sound data which represents a sound used in a generation of masking sound data;
obtaining speaker sound data which represents a voice of a speaker which is a masking target;
specifying each level of two or more frequency bands in the speaker sound data; and
setting each level of two or more frequency bands in the source sound data, corresponding to the two or more frequency bands in the speaker sound data, in accordance with predetermined rules on the basis of the each level of the frequency bands in the speaker sound data specified by a process of the specifying to generate masking sound data which represents a masking sound,
wherein in a process of the setting, each level of at least two frequency bands among from the two or more frequency bands in the source sound data is set in accordance with the predetermined rules which are different to each other.

6. The method according to claim 5, wherein in the process of the setting, each level of the at least two frequency bands in the source sound data is set in accordance with the predetermined rules having different relationships between each level of the at least two frequency bands in the speaker sound data specified by the process of the specifying and a gain relating to the levels of the source sound data; and
wherein the gain relating to the levels of the source sound data is a ratio of each level of the at least two frequency bands in the source sound data after the setting to each level thereof before the setting.

7. The method according to claim 5,
wherein in the process of the setting, each level of the at least two frequency bands among from the two or more frequency bands in the source sound data is set in accordance with the predetermined rules having different response speeds until reaching a convergent value corresponding to each level of the at least two frequency bands in the speaker sound data specified by the process of the specifying.

8. The method according to claim 5, further comprising:
obtaining background noise data which represents a background noise; and
specifying each level of two or more frequency bands in the background noise data,
wherein in the process of the setting, each level of two or more frequency bands in the source sound data, corresponding to the two or more frequency bands in the background noise data, is set in accordance with a predetermined rule on the basis of the each level of the frequency bands in the background noise data specified by the band level specifying portion in the generation of the masking sound data.

9. A masking sound generating system comprising:
a sound receiving device that generates speaker sound data by receiving a voice of a speaker which is a masking target and outputs the speaker sound data;
a masking sound data generating device that generates masking sound data representing a masking sound; and
a sound emitting device that emits the masking sound data generated by the masking sound data generating device as the masking sound,
wherein the masking sound data generating device comprises:
a source sound data obtaining portion that obtains source sound data that represents a sound used in the generation of the masking sound data;
a speaker sound data obtaining portion that obtains the speaker sound data which is output from the sound receiving device;
a band level specifying portion that specifies each level of two or more frequency bands in the speaker sound data;
a band level setting portion that sets each level of two or more frequency bands in the source sound data, corresponding to the two or more frequency bands in the speaker sound data, in accordance with predetermined rules on the basis of the each level of the frequency bands in the speaker sound data specified by the band level specifying portion and that generates masking sound data which represents a masking sound; and
an outputting portion that outputs the masking sound data generated by the band level setting portion to the sound emitting device; and
wherein the band level setting portion sets each level of at least two frequency bands among from the two or more frequency bands in the source sound data in accordance with the predetermined rules which are different to each other.
